(19) United States
(12) Patent Application Publication
(10) Pub. No.: US 2025/0047796 A1
(43) Pub. Date: Feb. 6, 2025

(54) TRANSPORT APPARATUS THAT CORRECTS SKEW OF SHEET, AND IMAGE FORMING APPARATUS INCLUDING SUCH TRANSPORT APPARATUS

(71) Applicant: KYOCERA Document Solutions Inc., Osaka (JP)

(72) Inventor: Hideaki DOYO, Osaka (JP)

(73) Assignee: KYOCERA Document Solutions Inc., Osaka (JP)

(21) Appl. No.: 18/791,656

(22) Filed: Aug. 1, 2024

(30) Foreign Application Priority Data
Aug. 4, 2023 (JP) 2023-127619

(51) Int. Cl. H04N 1/00

(52) U.S. Cl. CPC H04N 1/00602; H04N 1/00604; H04N 1/00721

(57) ABSTRACT

A transport apparatus includes a transport device, an abutment member, and a displacement device. The transport device transports a sheet in a first direction, corresponding to a sheet transport direction. The abutment member is located on one side of the transport device, in a second direction intersecting the first direction, to be abutted against a side of the sheet on the one side in the second direction. The displacement device displaces the sheet toward the one side in the second direction, in contact with the sheet.

### INCORPORATION BY REFERENCE

This application claims priority to Japanese Patent Application No. 2023-127619 filed on Aug. 4, 2023, the entire contents of which are incorporated by reference herein.

### BACKGROUND

The present disclosure relates to a transport apparatus and an image forming apparatus.

Some of existing medium feeding devices incorporated in an image forming apparatus include a medium container and a medium guide. The medium container is for stacking thereon a plurality of media. The medium guide regulates the position of the media placed on the medium container. The medium guide includes a guide surface, and a pair of guide members that each rotate about a rotary shaft extending along the direction in which the media are stacked on the medium container. The pair of guide members are located on the respective sides of the media in the width direction thereof, to guide the posture of the media from the respective sides.

### SUMMARY

The disclosure proposes further improvement of the foregoing techniques.

In an aspect, the disclosure provides a transport apparatus including a transport device, an abutment member, and a displacement device. The transport device transports a sheet in a first direction, corresponding to a sheet transport direction. The abutment member is located on one side of the transport device, in a second direction intersecting the first direction, to be abutted against an edge of the sheet on the one side in the second direction. The displacement device displaces the sheet toward the one side in the second direction, in contact with the sheet.

In another aspect, the disclosure provides an image forming apparatus including the foregoing transport apparatus, and an image forming device. The image forming device forms an image on the sheet.

### BRIEF DESCRIPTION OF THE DRAWINGS

FIG. 1 is a schematic cross-sectional view showing a configuration of an image forming apparatus, including a transport apparatus according to an embodiment of the disclosure;

FIG. 2 is a plan view of the transport apparatus shown in FIG. 1;

FIG. 3 is a plan view of an abutment member and a displacement device shown in FIG. 2;

FIG. 4 is a perspective view showing the displacement device;

FIG. 5 is a cross-sectional view taken along a line V-V in FIG. 2;

FIG. 6 is a schematic drawing showing the displacement of a sheet, contacted by the displacement device at a first position;

FIG. 7 is a schematic drawing showing the displacement of the sheet, contacted by the displacement device at a position other than the first position;

FIG. 8 is a schematic drawing showing an early phase of sheet posture detection;

FIG. 9 is a schematic drawing showing a middle phase of the sheet posture detection;

FIG. 10 is a schematic drawing showing a late phase of the sheet posture detection;

FIG. 11 is a plan view showing the abutment member;

FIG. 12 is a block diagram showing an electrical configuration of the image forming apparatus; and

FIG. 13 and FIG. 14 are flowcharts each showing a process for correcting the posture of the sheet.

### DETAILED DESCRIPTION

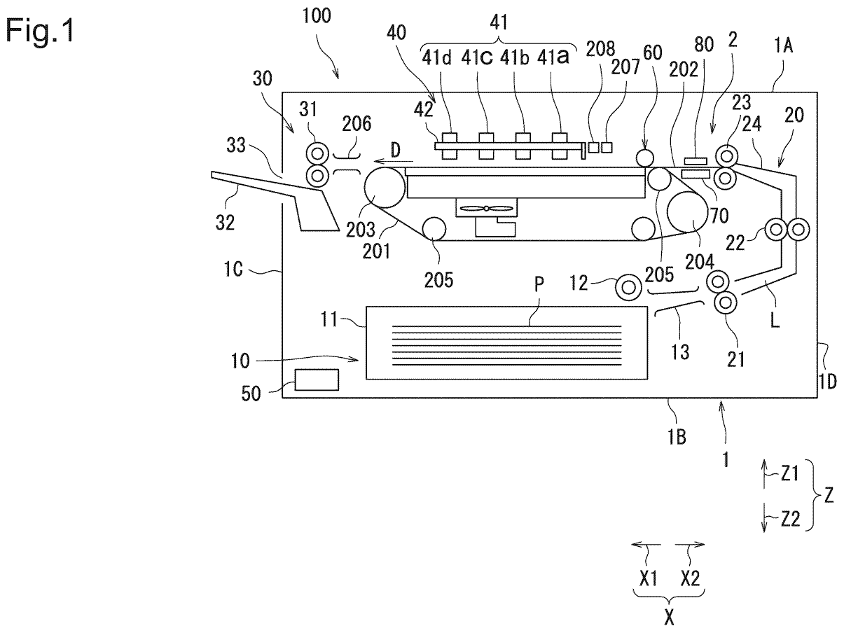

Hereafter, a transport apparatus and an image forming apparatus according to an embodiment of the disclosure will be described, with reference to the drawings (FIG. 1 to FIG. 14). In the drawings, the same or corresponding elements are given the same numeral, and the description of such elements will not be repeated.

Referring first to FIG. 1, the image forming apparatus 100 will be described hereunder. FIG. 1 illustrates a configuration of the image forming apparatus 100, including a transport apparatus 2 according to the embodiment of the disclosure.

The image forming apparatus 100 is an ink jet recording apparatus, such as a monochrome printer or a color printer capable of performing duplex printing, configured to form an image on a printing sheet P (hereinafter, simply sheet P) with aqueous ink. The printing sheet P may be any of, for example, a plain paper, a copy paper, a recycled paper, a thin paper, a thick paper, or a glossy paper. The sheet P exemplifies the “sheet” in the disclosure.

As shown in FIG. 1, the image forming apparatus 100 includes a casing 1, the transport apparatus 2, a sheet feeding device 10, a transport device 20, a delivery device 3, an image forming device 40, and a control device 50.

In this embodiment, the side to which the sheet P is transported from the transport device 20 toward the delivery device 30 in the image forming apparatus 100 will be defined as X1-side, and the opposite side will be defined as X2-side. The left side of the image forming apparatus 100 viewed from the X1-side will be defined as Y1-side, and the opposite side will be defined as Y2-side. Further, the side on which a top face 1A of the image forming apparatus 100 is located, in a Z-direction orthogonal to both of the X-direction and the Y-direction of the image forming apparatus 100 will be defined as upper side Z1, and the opposite side will be defined as lower side Z2. However, such directions are not intended to limit the orientation in use, of the image forming apparatus 100 according to the disclosure.

The casing 1 covers the outer periphery of the transport apparatus 2 and the image forming device 40. The casing 1 includes the top face 1A, a bottom face 1B, a front face 1C, a rear face 1D, and a pair of non-illustrated side faces.

The sheet feeding device 10 supplies the sheet P to the transport device 20. As shown in FIG. 1, the sheet feeding device 10 includes a sheet cassette 11, a feeding roller 12, and a first guide plate 13. The sheet cassette 11 is removably mounted in the casing 1. The sheet cassette 11 accommodates therein a plurality of sheets P. The feeding roller 12 is located on the upper side of the X2-side end portion of the sheet cassette 11. The feeding roller 12 picks up the sheets P stored in the sheet cassette 11 one by one, from the uppermost one. The first guide plate 13 is located between the feeding roller 12 and the transport device 20, to guide the sheet P picked up by the feeding roller 12, to the transport device 20.

The transport device 20 serves to transport the sheet P to the transport apparatus 2. The transport device 20 includes a second guide plate 24. The second guide plate 24 forms a generally C-shaped transport route L. The transport device 20 includes a first roller pair 21 located at the entrance of the transport route L, a second roller pair 22 located halfway of the transport route L, and a supply roller pair 23 located at the exit of the transport route L.

The first roller pair 21 and the second roller pair 22 are feeding roller pair that feed the sheet P forward, along the transport route L. The first roller pair 21 pinches therebetween the sheet P guided by the first guide plate 13, thereby feeding the sheet P to the transport route L. The second roller pair 22 pinches therebetween the sheet P delivered from the first roller pair 21, thereby feeding the sheet P to the supply roller pair 23.

The supply roller pair 23 detains the sheet P delivered from the second roller pair 22. After temporarily detaining the sheet P, the supply roller pair 23 supplies the sheet P to the transport apparatus 2, in accordance with the timing for the image forming operation.

The image forming device 40 forms an image on the sheet P. To the image forming device 40, the transport apparatus 2 supplies the sheet P. As shown in FIG. 1, the image forming device 40 includes recording heads 41 and a head base 42.

The recording heads 41 include a recording head 41a, a recording head 41b, a recording head 41c, and a recording head 41d. The four recording heads, namely the recording head 41a, the recording head 41b, the recording head 41c, and the recording head 41d are aligned in this order on the head base 42, from the X2-side toward the X1-side. In this embodiment, the recording heads 41 are of a line type. In other words, the image forming apparatus 100 is a line-head type ink jet recording apparatus. Hereinafter, the recording head 41a, the recording head 41b, the recording head 41c, and the recording head 41d will be collectively referred to as “recording heads 41”, unless otherwise specifically noted.

The four recording heads 41 each include a plurality of non-illustrated nozzles. The ink of each color is ejected from the nozzles of the recording head 41, onto the sheet P passing the position opposed to the recording head 41. Accordingly, in image including characters or figures is formed on the sheet P.

The delivery device 30 delivers the sheet P to outside. As shown in FIG. 1, the delivery device 30 includes a delivery roller pair 31, an output tray 32, and a sheet outlet 33. The output tray 32 is fixed to the casing 1, so as to stick out from the sheet outlet 33 formed in the front face 1C of the casing 1. The sheet outlet 33 is a through hole formed in the front face 1C of the casing 1.

The delivery roller pair 31 delivers the sheet P transported by the transport apparatus 2, to the sheet outlet 33. The sheet P delivered from the delivery roller pair 31 is delivered to outside of the casing 1, through the sheet outlet 33. The sheet P delivered through the sheet outlet 33 is received by the output tray 32.

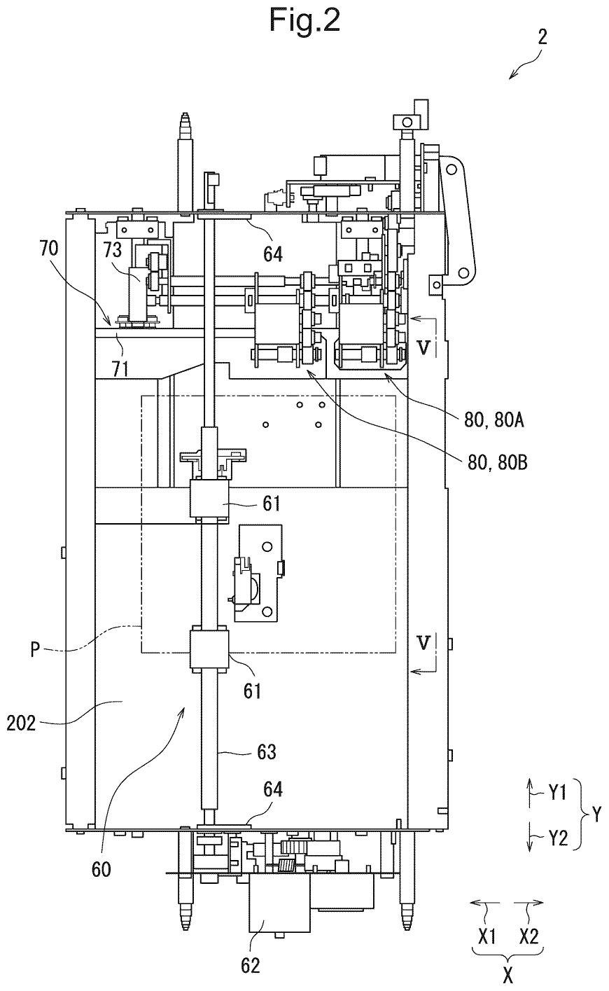

Referring now to FIG. 2, the transport apparatus 2 will be described hereunder. FIG. 2 is a plan view of the transport apparatus 2 shown in FIG. 1.

The transport apparatus 2 transports the sheet P from the transport device 20 to the image forming device 40. As shown in FIG. 1, the transport apparatus 2 includes a transport belt 201, a transport plate 202, a drive roller 203, a tension roller 204, guide rollers 205, and a third guide plate 206. The transport belt 201 is an endless belt that moves along the surface of the transport plate 202. The transport belt 201 is stretched around the drive roller 203, the tension roller 204, and the guide rollers 205. Although a plurality of guide rollers 205 are provided in this embodiment, a single piece of guide roller 205 may be provided.

The sheet P is transported by the transport belt 201 toward the X1-side. The sheet P passes the position opposed to the recording head 41, while being transported by the transport belt 201. The recording head 41 ejects the ink onto the sheet P passing the position opposed to the recording head 41, thereby forming an image on the sheet P. The sheet P having the image formed thereon by the recording head 41 is transported by the transport belt 201 toward the third guide plate 206. The direction toward the X1-side corresponds, for example, to the “first direction” in the disclosure.

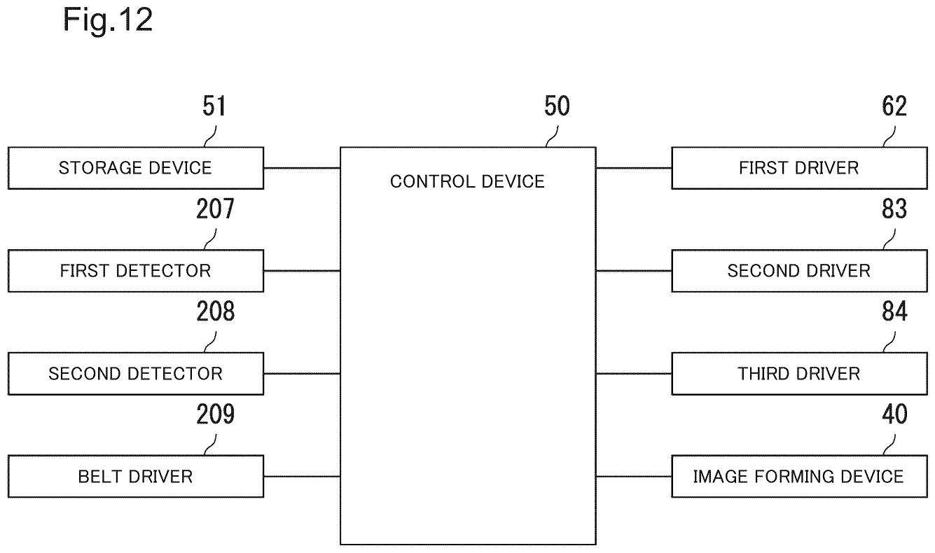

The drive roller 203 is driven so as to rotate, by a belt driver 209 (see FIG. 12). The belt driver 209 causes the transport belt 201 to revolve counterclockwise in FIG. 2.

The tension roller 204 applies tension to the transport belt 201, to prevent the transport belt 201 from sagging.

The plurality of guide rollers 205 are spaced from each other in the Z-direction. Such a configuration provides a space on the lower side Z2 of the transport surface of the transport belt 201. Accordingly, in the case where a negative pressurizer is provided in the transport apparatus 2, the transport belt 201 can be prevented from contacting the negative pressurizer.

The third guide plate 206 is connecting between the transport apparatus 2 and the delivery device 30. The third guide plate 206 serves to guide the sheet P to the delivery device 30, via the delivery roller pair 31.

The transport apparatus 2 further includes a transport device 60, an abutment member 70, a displacement device 80, a first detector 207, and a second detector 208.

The transport device 60 transports the sheet P toward the X1-side. As shown in FIG. 2, the transport device 60 includes transport rollers 61 that moves the sheet Pin contact therewith. In addition, the transport device 60 includes a first driver 62, a support shaft 63, and a pair of support plates 64.

The transport rollers 61 serve to transport the sheet P. The transport rollers 61 transport the sheet P, in collaboration with the belt driver 209. The transport rollers 61 are opposed to the transport plate 202. The transport rollers 61 guides the sheet P delivered from the supply roller pair 23 toward the X1-side, with a pressure applied toward the lower side Z2. Here, the transport rollers 61 are not limited to follower rollers. The transport rollers 61 may be connected to a non-illustrated drive motor, to provide a driving function. Further, the transport rollers 61 may be located so as to oppose the transport plate 202, via the transport belt 201.

The support shaft 63 supports the transport rollers 61. The support shaft 63 extends in the Y-direction. The support shaft 63 rotatably supports, for example, a left and right pair of transport rollers 61, at a central position in the Y-direction. The support shaft 63 is supported by the left and right pair of support plates 64, extending in the X-direction.

The first driver 62 is, for example, a motor that serves as a drive source for providing a rotating force. The first driver 62 elevates and lowers the support shaft 63 in the Z-direction, via the support plates 64. To transport the sheet P, the first driver 62 lowers the support shaft 63 to the lower side Z2 via the support plates 64, thereby bringing the transport rollers 61 into contact with the sheet P. When the sheet P is not to be transported, the first driver 62 elevates the support shaft 63 to the upper side Z1 via the support plates 64, thereby moving the transport rollers 61 away from the sheet P.

The abutment member 70 makes contact with an edge of the sheet P on one side in the Y-direction. The abutment member 70 is located on the Y1-side of the transport device 60, along the transport direction. The abutment member 70 is movable in the Y-direction. Accordingly, the abutment member 70 is located on the Y1-side of the transport device 60, thus to be abutted against the edge of the sheet P on the Y1-side. The Y-direction corresponds, for example, to the “second direction”, and the Y1-side corresponds, for example, to the “one side in the second direction”, in the disclosure. The Y-direction is intersecting the X-direction.

The abutment member 70 includes a main body 71 and a guide portion 73. The main body 71 is formed in an elongate shape extending in the X-direction. The main body 71 is movable in the Y-direction. When the main body 71 moves toward the Y2-side, a non-illustrated stopper provided on the main body 71 is abutted against a non-illustrated reference plate provided on the lower face of the transport plate 202, so that the movement of the main body 71 is stopped. The guide portion 73 is fixed to the surface of the main body 71 on the Y1-side.

The displacement device 80 displaces the sheet P. To be more specific, the displacement device 80 displaces the sheet P toward the Y1-side, in contact therewith. Accordingly, in the Y-direction intersecting the X-direction, which corresponds to the transport direction, the displacement device 80 brings the edge of the sheet P on the Y1-side into contact with the abutment member 70. Therefore, in the event that the sheet P is skewing with respect to the transport direction, the sheet P is made to rotate about the position brought into contact with the abutment member 70, as the fulcrum. As result, the transport apparatus 2 can correct the skew with a simple structure.

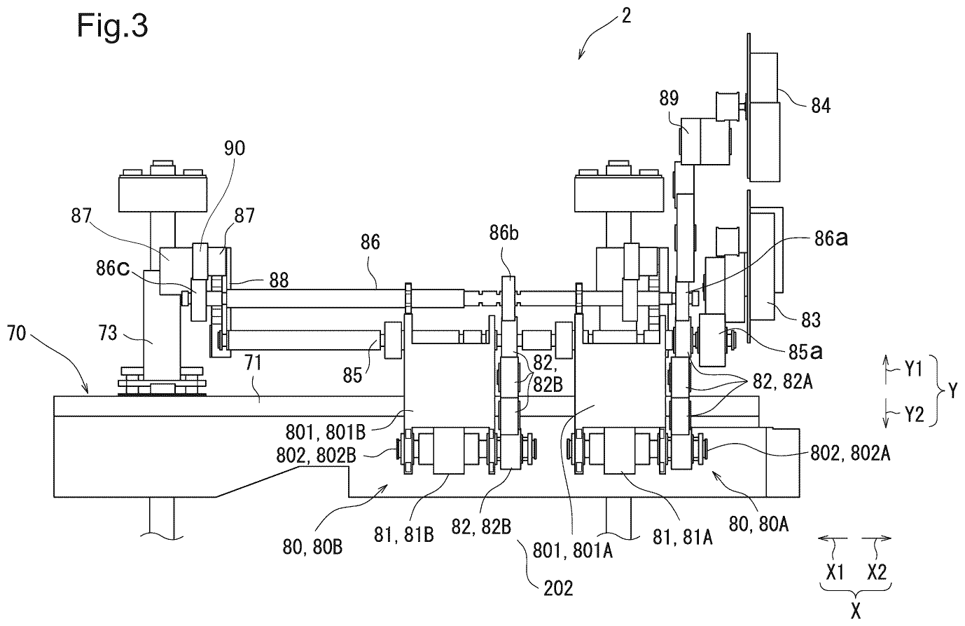

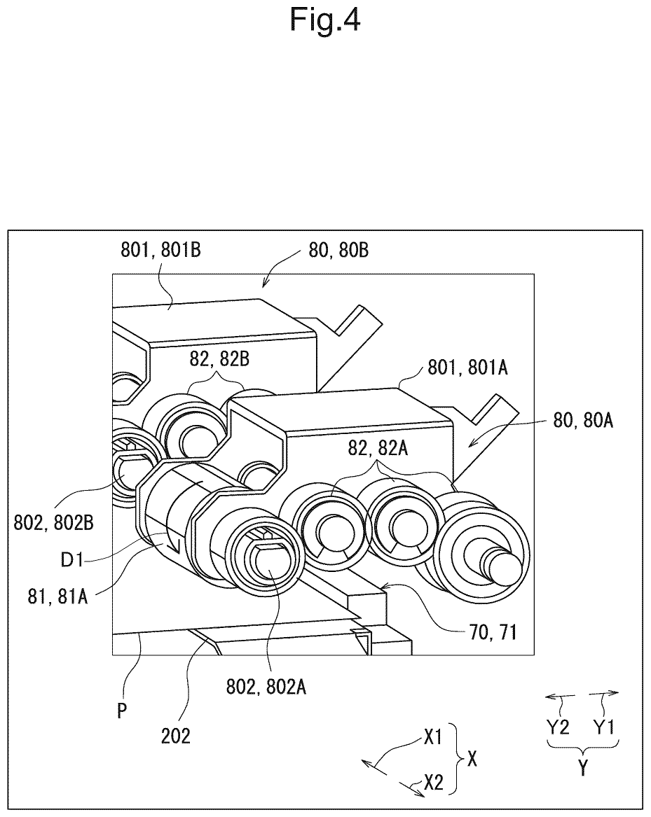

Referring now to FIG. 3 and FIG. 4, the transport apparatus 2 will be described in further detail. FIG. 3 is a plan view of the abutment member 70 and the displacement device 80 shown in FIG. 2. FIG. 4 is a perspective view showing the displacement device 80.

As shown in FIG. 3, the displacement device 80 includes a first displacement device 80A, a second displacement device 80B, a second driver 83, and a third driver 84.

The first displacement device 80A and the second displacement device 80B are supported by a first shaft 85 extending in the X-direction. The first displacement device 80A and the second displacement device 80B perform the same action, in synchronization with each other. The second displacement device 80B is located downstream of the first displacement device 80A, in the X-direction, in other words the sheet transport direction. A roller 85a is fixed to an end portion of the first shaft 85 on the upstream side, in the X-direction, in other words the sheet transport direction.

The second driver 83 is, for example, a motor that serves as a drive source for providing a rotating force. The roller 85a transmits the rotating force of the second driver 83 to the first shaft 85. When the first shaft 85 is made to rotate forward, the first displacement device 80A and the second displacement device 80B are made to pivot toward the lower side Z2, by such forward rotation. When the first shaft 85 is made to rotate reversely, the first displacement device 80A and the second displacement device 80B are made to pivot toward the upper side Z1.

The first displacement device 80A includes a displacement roller 81A that displaces the sheet P in contact therewith. The first displacement device 80A also includes an arm portion 801A, a shaft 802A, and transmission rollers 82A. The second displacement device 80B includes a displacement roller 81B that displaces the sheet P in contact therewith. The second displacement device 80B also includes an arm portion 801B, a shaft 802B, and transmission rollers 82B. Since the first displacement device 80A and the second displacement device 80B have the same structure, these displacement devices will hereinafter be collectively referred to as displacement device 80, unless otherwise specifically noted. Likewise, the arm portions 801A, 801B, the shafts 802A, 802B, the displacement rollers 81A, 81B, and the transmission rollers 82A, 82B will also be collectively referred to as arm portion 801, shaft 802, displacement roller 81, and transmission roller 82, respectively.

The arm portion 801 has the end portion on the Y1-side supported by the first shaft 85. The end portion of the arm portion 801 on the Y2-side supports the shaft 802. The shaft 802 rotatably supports the displacement roller 81. When the second driver 83 rotates the first shaft 85 forward, the arm portion 801 is made to pivot toward the lower side Z2, about the first shaft 85. The pivotal motion of the arm portion 801 toward the lower side Z2 about the first shaft 85 causes the displacement roller 81 to press the sheet P toward the lower side Z2. When the second driver 83 rotates the first shaft 85 reversely, the arm portion 801 is made to pivot toward the upper side Z1, about the first shaft 85. The pivotal motion of the arm portion 801 toward the upper side Z1 about the first shaft 85 causes the displacement roller 81 to move away from the sheet P, toward the upper side Z1. The clearance between the displacement roller 81 and the transport plate 202, defined by the forward rotation of the first shaft 85 caused by the second driver 83, is prespecified to a constant value. Accordingly, the pressing force applied by the displacement roller 81 to a thicker sheet P is larger than the pressing force applied by the displacement roller 81 to a thinner sheet P.

As shown in FIG. 4, the arm portion 801 supports the displacement roller 81 and the transmission roller 82. The transmission roller 82 may be constituted of a single roller, or include a plurality of rollers. As shown in FIG. 3, the rotating force is transmitted to the transmission roller 82, via the second shaft 86.

The second shaft 86 extends in the X-direction. The second shaft 86 includes a roller 86a, a roller 86b, and a roller 86c. The roller 86a is located on the end portion on the X2-side, and the roller 86c is located on the end portion on the X1-side. The roller 86b is located at a central position of the second shaft 86, in the X-direction.

The third driver 84 is, for example, a motor that serves as a drive source for providing a rotating force. The roller 86a receives the rotating force from the third driver 84, via the roller 89. The rotating force transmitted to the roller 86a is transmitted to the displacement roller 81A, via the plurality of transmission rollers 82A. When the displacement roller 81A is made to rotate in the direction indicated by an arrow D1 in FIG. 4, in the state where the first displacement device 80A is lowered, the sheet P is displaced toward the Y1-side.

When the rotating force is transmitted to the roller 86a, such rotating force causes the second shaft 86 to rotate, so that the roller 86b and the roller 86c are also made to rotate interlocked with the second shaft 86. The rotating force of the roller 86b is transmitted to the displacement roller 81B, via the plurality of transmission rollers 82B. When the displacement roller 81B is made to rotate in the direction of the arrow D1, in the state where the second displacement device 80B is lowered, the sheet P is displaced toward the Y1-side.

The rotating force transmitted to the roller 86c is transmitted to a rack 87, via a pinion 90. The rack 87 is unified with the guide portion 73. Accordingly, the guide portion 73 moves in the Y-direction, in synchronization with the rotation of the rack 87. The pinion 90 rotates about a rotary shaft extending in the X-direction. When the displacement roller 81 is made to rotate in the direction of the arrow D1 in FIG. 4, the pinion 90 rotates in the direction that causes the rack 88 and the guide portion 73 to move toward the Y2-side. At the same time, the main body 71 fixed to the guide portion 73 also moves toward the Y2-side, interlocked therewith. Accordingly, the displacement of the sheet P toward the Y1-side, and the movement of the abutment member 70 toward the Y2-side, are done in synchronization with each other.

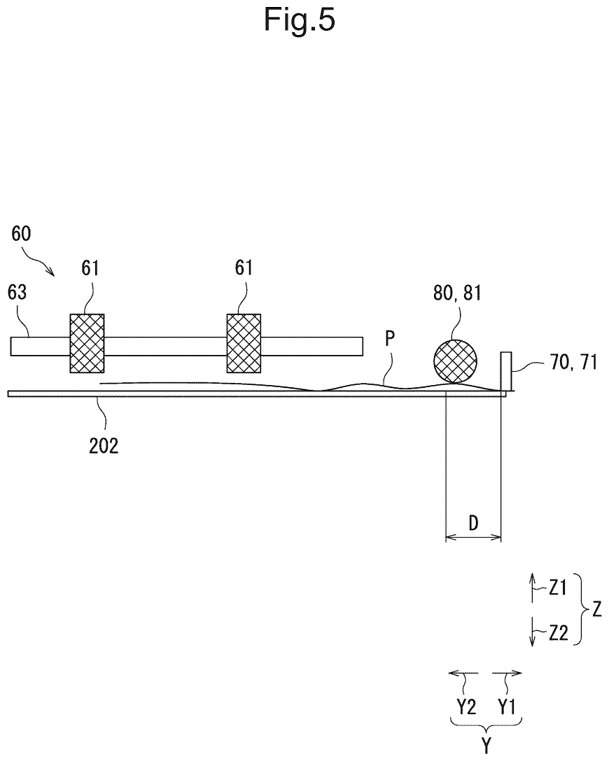

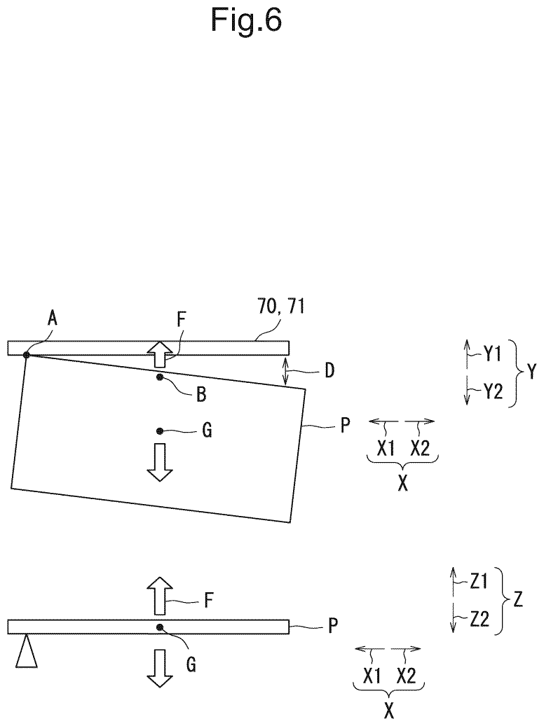

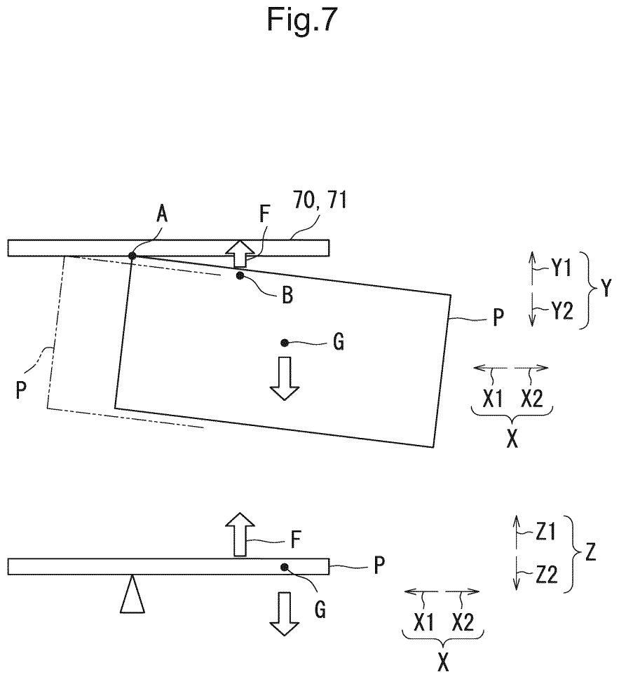

Referring now to FIG. 5 to FIG. 7, the working of the transport apparatus 2 will be described hereunder. FIG. 5 is a cross-sectional view taken along a line V-V in FIG. 2. FIG. 6 is a schematic drawing showing the displacement of the sheet P, contacted by the displacement device 80 at a first position A1. FIG. 7 is a schematic drawing showing the displacement of the sheet P, contacted by the displacement device 80 at a position other than the first position A1.

In the transport apparatus 2, when the sheet P reaches a target stop position on the transport plate 202 in the X-direction (a predetermined target stop position for performing the skew correction, for example the position where the leading edge of the sheet P in the transport direction is under the transport roller 61), a control device 50 (see FIG. 12) causes the transport roller 61 to stop transporting the sheet P. In this embodiment, the control device 50 stops the transport belt 201, by stopping the drive roller 203. The control device 50 stops the transport roller 61, in synchronization with the stopping of the transport belt 201. After causing the transport roller 61 to stop transporting the sheet P, the control device 50 causes the first driver 62 to elevate the transport roller 61. Through the mentioned process, the sheet P is stopped at the target stop position. The position on the sheet P contacted by the displacement device 80, when the sheet P is located at the target stop position, corresponds to the first position A1 in the X-direction. As shown in FIG. 5, the control device 50 lowers the displacement roller 81 toward the Z2-side, after elevating the transport roller 61.

As shown in FIG. 6, when the displacement roller 81 is made to rotate in the direction of the arrow D1 (hereinafter, forward rotation), in the state where the sheet P is located at the target stop position in a skewed posture, the displacement roller 81 exerts a force F to the sheet P. The sheet P is displaced toward the Y1-side, and the main body 71 is displaced toward the Y2-side. When the end portion of the sheet P, in the Y-direction on the X1-side, is first abutted against the main body 71, the end portion of the sheet P on the X2-side and the main body 71 are spaced from each other by a distance D. Thus, when the sheet P is first abutted against the main body 71, the displacement device 80 makes contact with the sheet P at the first position A1, in the X-direction.

When the displacement device 80 thus makes contact with the sheet P at the first position A1, a point of action B, where the displacement device 80 exerts a force to the sheet P to the Y1-side, falls on a position on the X2-side with respect to the position where the sheet P is first abutted against the abutment member 70 (fulcrum A), and in the proximity of the center of gravity G of the sheet P in the X-direction, as shown in FIG. 6. Here, the point of action B may be set to be located on the X2-side with respect to the center of gravity G, in other words the position opposite to the fulcrum A, with respect to the center of gravity G. Accordingly, when the displacement device 80 exerts the force to the sheet P at the point of action B toward the Y1-side, the sheet P is made to rotate about the fulcrum A, in the direction to reduce the distance D. In FIG. 6, the sheet P rotates counterclockwise about the fulcrum A. In other words, the sheet P is made to rotate about the rotation center corresponding to the position where the sheet P first made contact with the abutment member 70. Thus, the skew of the sheet P is corrected.

In contrast, when the sheet P in the skewed posture has stopped, as shown in FIG. 7, at a position shifted toward the X2-side, from the sheet P stopped at the target stop position (indicated by dash-dot-dot lines in FIG. 7), the point of action B may be located between the position where the sheet P is first abutted against the abutment member 70 (fulcrum A) and the center of gravity G of the sheet P. In this case, although the displacement roller 81 rotates forward, thereby causing the displacement device 80 to exert the force to the sheet P at the point of action B toward the Y1-side, the sheet P is not made to smoothly rotate. Accordingly, when the sheet P has stopped at a position shifted from the target stop position in the X-direction, the control device 50 modifies the detail of the control so as to make the sheet P accurately stop at the target stop position, with respect to the sheets P to be subsequently transported, as will be described later in further detail.

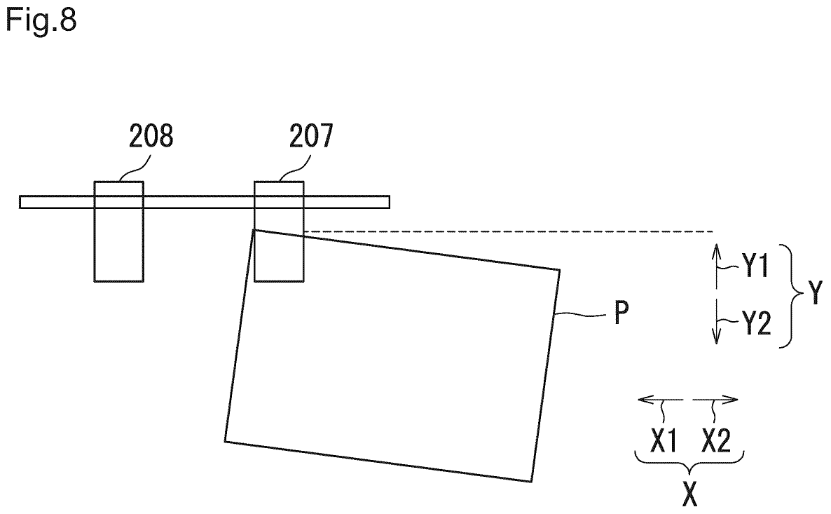

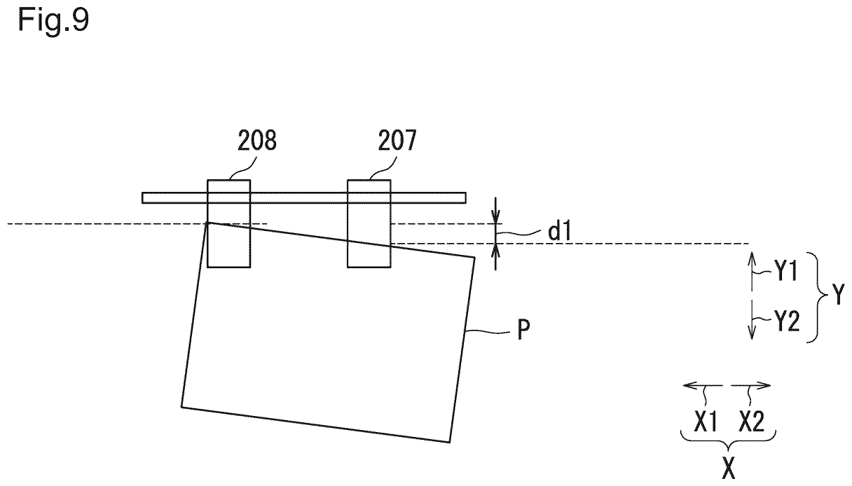

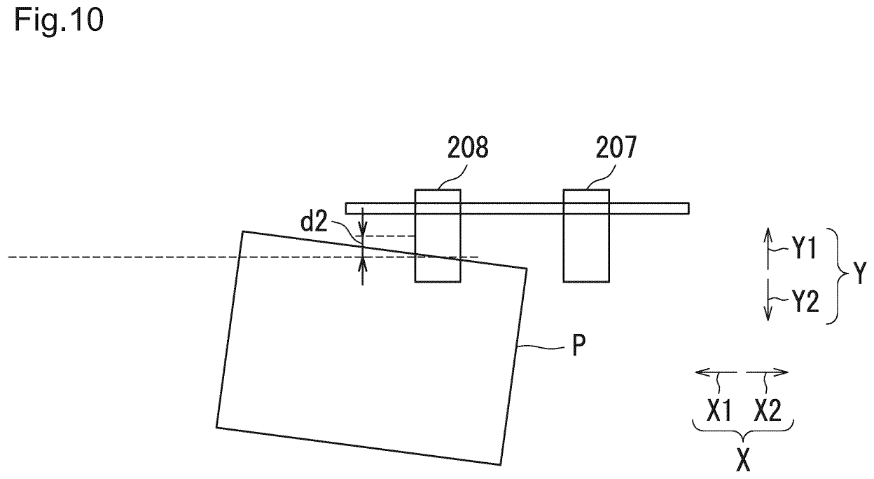

Referring now to FIG. 8 to FIG. 10, the detection of the skew of the sheet P will be described hereunder. FIG. 8 is a schematic drawing showing an early phase of posture detection of the sheet P. FIG. 9 is a schematic drawing showing a middle phase of the posture detection of the sheet P. FIG. 10 is a schematic drawing showing a late phase of the posture detection of the sheet P.

As shown in FIG. 1, the transport apparatus 2 includes the first detector 207 and the second detector 208. The first detector 207 and the second detector 208 are image sensors such as a CCD sensor or a CMOS sensor. The first detector 207 and the second detector 208 are located on the X1-side (downstream side in the sheet transport direction) with respect to the transport roller 61, and aligned in the X-direction, on the upper side Z1 of the transport belt 201. The second detector 208 is located on the X1-side (downstream side in the sheet transport direction) with respect to the first detector 207. Thus, the first detector 207 and the second detector 208 serve to detect the posture of the sheet P that has reached the position downstream of the abutment member 70, in the sheet transport direction. The first detector 207 and the second detector 208 correspond to the “detector” in the disclosure.

As shown in FIG. 8, while the sheet P is being transported toward the X1-side, the first detector 207 detects the position where the front edge of the sheet P on the Y1-side (left front corner) has passed, as an early phase of the posture detection. When the sheet P proceeds further, the first detector 207 detects, as a middle phase of the posture detection, the position where the central portion of the edge of the sheet P on the Y1-side (center on the left side) has passed, as shown in FIG. 9. The first detector 207 outputs the images respectively shot in the early phase and the middle phase of the posture detection to the control device 50, so that the control device 50 detects a difference d1 between the position where the front end portion has passed and the position where the central portion has passed, on the basis of the images received.

Likewise, in the middle phase of the posture detection, the second detector 208 detects the position where the front end portion of the sheet P on the Y1-side has passed. The second detector 208 detects, as a late phase of the posture detection, the position where the central portion of the sheet P on the Y1-side has passed. The second detector 208 outputs the images respectively shot in the middle phase and the late phase of the posture detection to the control device 50, so that the control device 50 detects a difference d2 between the position where the front end portion has passed and the position where the central portion has passed, on the basis of the images received. Further, the control device 50 decides the posture of the sheet P, on the basis of the difference dl and the difference d2. Here, the control device 50 decides that the correction of the posture of the sheet P is insufficient, when the average of the difference d1 and the difference d2 is larger than a predetermined threshold.

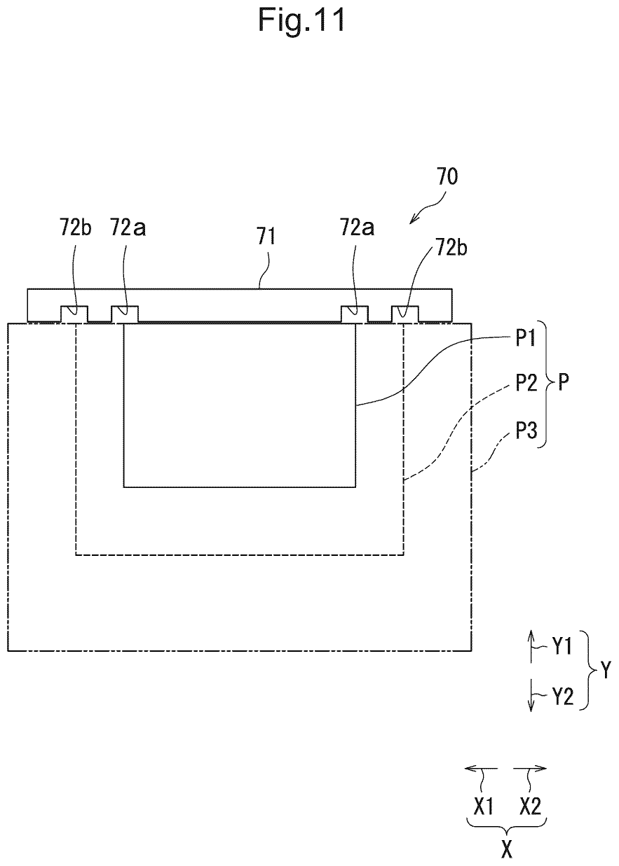

Referring now to FIG. 11, the abutment member 70 will be described hereunder. FIG. 11 is a plan view showing the abutment member 70.

As shown in FIG. 11, the main body 71 includes a pair of recessed portions 72a aligned in the X-direction, and a pair of recessed portions 72b aligned in the X-direction. The abutment member 70 includes the recessed portions 72a and the recessed portions 72b, each recessed from the Y2-side toward the Y1-side in the second direction. The main body 71 is smaller in size in the X-direction, than a sheet P3.

The transport apparatus 2 stops transporting the sheet P, under the control of the control device 50, at the position where the displacement device 80 makes contact with the sheet P at the first position A1. Now, the positional relation between the sheet P and the main body 71 is determined, in the X-direction. The two recessed portions 72a and the two recessed portions 72b are formed at different positions in the X-direction, on the basis of the positional relation between the between the sheet P and the main body 71. It will be assumed here, that the transport apparatus 2 selectively transports one of a sheet P1 of a small size, a sheet P2 of a middle size, and the sheet P3 of a large size. When transporting the sheet P1, the transport apparatus 2 stops transporting the sheet P1, under the control of the control device 50, at the position where the leading edge of the sheet P1 in the X-direction is located at one of the recessed portions 72a, and the trailing edge of the sheet P1 in the X-direction is located at the other recessed portion 72a. Likewise, when transporting the sheet P2, the transport apparatus 2 stops transporting the sheet P2, under the control of the control device 50, at the position where the leading edge of the sheet P2 in the X-direction is located at one of the recessed portions 72b, and the trailing edge of the sheet P2 in the X-direction is located at the other recessed portion 72b. Further, when transporting the sheet P3, the transport apparatus 2 stops transporting the sheet P3, under the control of the control device 50, at the position where the leading edge of the sheet P3 in the X-direction is deviated from the, and the trailing edge of the sheet P3 in the X-direction is also deviated from the main body 71. Therefore, when the posture correction of the sheet P1, sheet P2, or sheet P3 is to be performed, the corner portion of the sheet P1, sheet P2, or sheet P3 can be prevented from contacting the main body 71.

Accordingly, the abutment member 70 makes a first contact with the sheet P, at a position other than the end portion on the X1-side or X2-side. In other words, the end portion of the edge of the sheet P, which is the corner portion, can be prevented from contacting the abutment member 70. Therefore, the area via which the sheet P makes contact with the main body 71, when the sheet P rotates about the corner portion of the edge, can be reduced. In addition, concentration of stress at the corner portion of the edge of the sheet P can be avoided. As result, the sheet P can be made to rotate, with reduced distortion at the end portion of the edge of the sheet P.

Referring now to FIG. 12, an electrical configuration of the image forming apparatus 100 will be described. FIG. 12 is a block diagram showing an exemplary electrical configuration of the image forming apparatus 100.

The image forming apparatus 100 includes the control device 50. The control device 50 includes a processor such as a central processing unit (CPU), a read-only memory (ROM) which is a non-volatile memory, and a random-access memory (RAM) which is a volatile memory. The control device 50 also includes an integrated circuit (IC) for the image forming operation. The IC for the image forming operation is, for example, includes an application-specific integrated circuit (ASIC). In the ROM, control programs for causing the CPU to execute various arithmetic operations are stored in advance. In the RAM, the arithmetic operations executed by the CPU are temporarily stored. The control device 50 controls the operation of the image forming apparatus 100, and the transport belt 201, the transport device 60, and the displacement device 80, by executing the control programs, stored in advance in the ROM or a storage device 51.

As shown in FIG. 12, the control device 50 is communicably connected, via a communication bus, to the storage device 51, the first detector 207, the second detector 208, the first driver 62, the second driver 83, the third driver 84, and the image forming device 40.

The storage device 51 includes, for example, a hard disk. Alternatively, the storage device 51 may be a non-volatile memory or the like. The storage device 51 contains, for example, the image data for printing, the control programs related to various control operation, and the data to be used by the control programs. The control programs include, for example, a program for controlling the image forming operation on the sheet P (hereinafter, “first control program”), and a program for executing the posture correction of the sheet P (hereinafter, “second control program”). Here, the first control program and the second control program may be stored in the ROM, instead of the storage device 51.

The first control program is for executing the image forming operation on the sheet P. The data to be used for the first control program includes, for example, the amount of the aqueous ink to be ejected onto the printing area.

The second control program is for controlling the first driver 62, the second driver 83, the third driver 84, and the belt driver 209. The data to be used for the second control program includes, for example, the detection values from the first detector 207 and the second detector 208, the size and the transport speed of the sheet P.

The control device 50 causes the displacement device 80 to resume the displacement of the sheet P, after causing the transport device 60 to stop transporting the sheet P. Therefore, the sheet P can be made to rotate, after the sheet P has stopped moving in the X-direction. As result, the sheet P can be surely rotated.

The control device 50 moves the transport roller 61 away from the sheet P, when the displacement device 80 moves the sheet P. In addition, the control device 50 moves the displacement roller 81 away from the sheet P, when transport device 60 transports the sheet P. Accordingly, the displacement device 80 and the transport device 60 are kept from exerting the force to the sheet P at the same time. Therefore, the sheet P can be displaced in different directions, with high accuracy.

The control device 50 controls the transport device 60, according to the posture of the sheet P decided on the basis of the images received from the first detector 207 and the second detector 208. To be more specific, first the control device 50 compares between the average value of the difference dl detected by the first detector 207 and the difference d2 detected by the second detector 208, and the decision threshold. Upon deciding that the average value is larger than the decision threshold, the control device 50 delays the timing to stop the transport of the sheet P. Accordingly, the position on the sheet P to be contacted by the displacement device 80 can be shifted toward the X2-side, such that the displacement device 80 makes contact with the sheet P at the first position A1. The corrected posture of the sheet P can be detected, and therefore the posture of the sheets P to be subsequently transported can also be corrected, on the basis of the corrected posture of the sheet P. As result, the skew of the sheet P can be corrected with high accuracy.

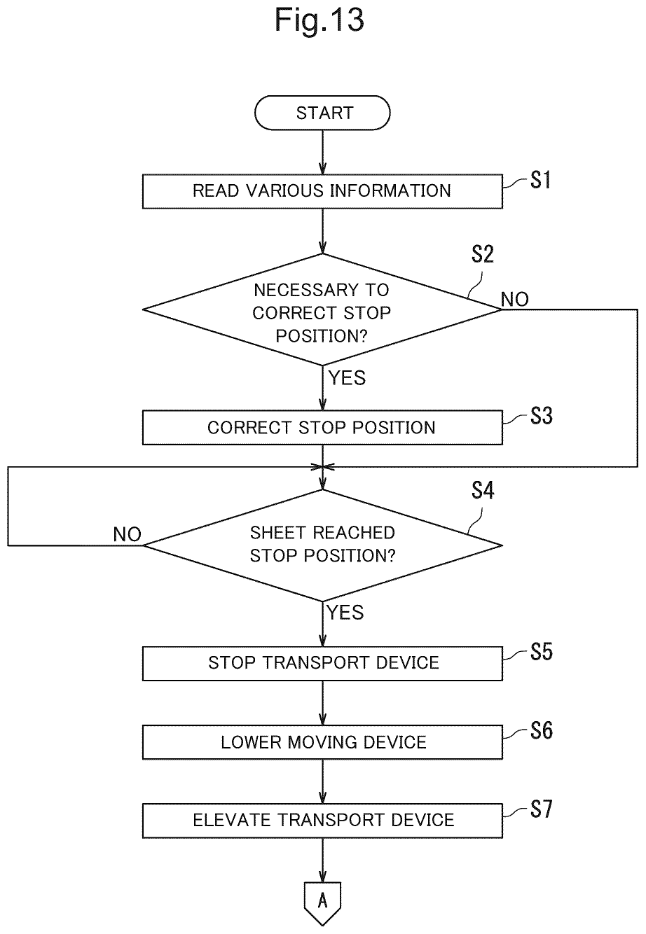

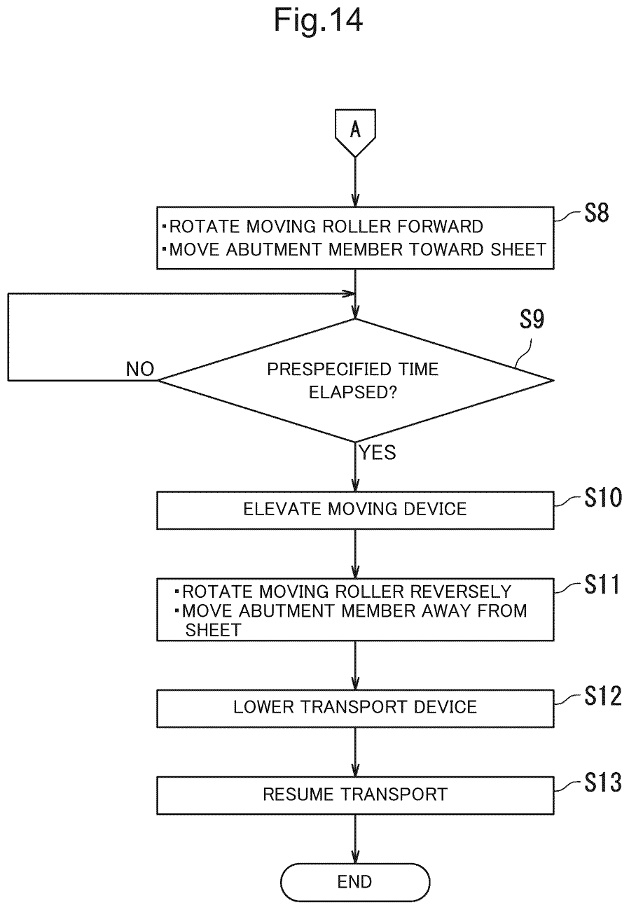

Referring now to FIG. 13 and FIG. 14, a posture correction process for the sheet P, performed by the control device 50, will be described hereunder. FIG. 13 and FIG. 14 are flowcharts each showing the process for correcting the posture of the sheet P. As shown in FIG. 13 and FIG. 14, the operation performed by the control device 50 includes step S1 to step S13. The operation of step S1 to step S13 is executed, when the processor of the control device 50 executes the second control program.

As shown in FIG. 13, the control device 50 reads various types of data necessary for the correction process, at step S1. Then the operation proceeds to step S2.

At step S2, the control device 50 decides whether it is necessary to correct the stop position of the sheet P. For example, the control device 50 decides, with respect to the sheet P transported earlier than the sheet P of the ongoing process, whether the posture correction of the sheet P is insufficient as above, on the basis of the images respectively shot by the first detector 207 and the second detector 208. Then upon deciding that the posture correction is insufficient, the control device 50 decides that the correction of the stop position of the sheet P is necessary.

When it is unnecessary to correct the stop position of the sheet P (No at step S2), the operation proceeds to step S4. When it is necessary to correct the stop position of the sheet P (Yes at step S2), the operation proceeds to step S3.

At step S3, the control device 50 corrects the stop position of the sheet P. The control device 50 modifies the control detail to be applied to the transport of the next sheet P, such that the sheet P stops accurately at the target stop position in the X-direction. For example, the control device 50 controls the transport device 60 to change the stop position, such that the sheet P stops at the position shifted from the stop position of the preceding sheet P toward the X1-side, by a predetermined distance. Then the operation proceeds to step S4.

At step S4, the control device 50 causes the sheet P to proceed in the X-direction, and decides whether the sheet P has reached the stop position, for example on the basis of an output from a non-illustrated detector, such as an optical sensor. In the case where the sheet P has not reached the stop position (No at step S4), the operation of step S4 is repeated. In the case where the sheet P has reached the stop position (Yes at step S4), the operation proceeds to step S5.

At step S5, the control device 50 stops the transport of the sheet P. The control device 50 turns off the belt driver 209, thereby causing the transport belt 201 and the transport device 60 to stop transporting the sheet P. Then the operation proceeds to step S6.

At step S6, the control device 50 controls the second driver 83, so as to lower the displacement device 80. Then the operation proceeds to step S7.

At step S7, the control device 50 controls the first driver 62, so as to elevate the transport device 60. Then the operation proceeds to step S8.

As shown in FIG. 14, the control device 50 controls the third driver 84, so as to cause the displacement roller 81 of the displacement device 80 to rotate forward, at step S8. Accordingly, the sheet P is made to move (rotate) toward the Y1-side, in other words toward the main body 71. The third driver 84 brings the main body 71 of the abutment member 70 closer to the sheet P, in synchronization with the motion of the displacement device 80. The main body 71 moves toward the Y2-side, until the stopper is abutted against the reference plate. Then the operation proceeds to step S9.

At step S9, the control device 50 decides whether the displacement device 80 and the abutment member 70 have been in operation for a prespecified time. In the case where the displacement device 80 and the abutment member 70 have not been in operation for the prespecified time (No at step S9), the operation of step S9 is repeated. In the case where the displacement device 80 and the abutment member 70 have been in operation for the prespecified time (Yes at step S9), the operation proceeds to step S10.

At step S10, the control device 50 controls the second driver 83, so as to elevate the displacement device 80. Then the operation proceeds to step S11.

At step S11, the control device 50 controls the third driver 84, so as to cause the displacement roller 81 of the displacement device 80 to rotate reversely. The third driver 84 causes the main body 71 of the abutment member 70 to move away from the sheet P toward the Y1-side, in synchronization with the motion of the displacement device 80. Then the operation proceeds to step S12.

At step S12, the control device 50 controls the first driver 62, so as to lower the transport device 60. Then the operation proceeds to step S13.

At step S13, the control device 50 resumes the transport of the sheet P. The control device 50 turns on the belt driver 209, thereby causing the transport belt 201 and the transport device 60 to resume the transport of the sheet P. At this point, the operation is finished.

The aforementioned existing medium feeding device and image forming apparatus are configured to correct the skew of the medium, by pressing the pair of guide members against the medium, from the respective sides of the medium in the width direction. However, in the case of the medium feeding device and the image forming apparatus configured as above, the pair of guide members have to be controlled in synchronization with each other. Therefore, the structure of the transport apparatus, the medium guide inclusive, becomes complicated. In contrast, with the configuration according to the foregoing embodiment, the skew of the sheet can be corrected, with a simple structure.

The embodiment of the disclosure has been described as above, with reference to the drawings. However, the disclosure is not limited to the foregoing embodiment, but may be modified in various manners, without departing from the scope of the disclosure. The drawings each schematically illustrate the elements for the sake of clarity, and the thickness, length, number of pieces, and interval of the illustrated elements may be different from the actual ones, because of the convenience in making up the drawings. Further, the material, shape, and size of the elements referred to in the foregoing embodiment are merely exemplary and not specifically limited, and may be modified as desired, without substantially departing from the configuration according to the disclosure.
(1) As described with reference to FIG. 1 to FIG. 14, the correction of the posture by the abutment member 70 and the displacement device 80 is started, after the sheet P is stopped, according to the foregoing embodiment. However, the disclosure is not limited to such embodiment. The correction of the posture according to the disclosure may include causing the abutment member 70 and the displacement device 80 to operate, without stopping the transport of the sheet P.
(2) As described with reference to FIG. 1 to FIG. 14, the transport rollers 61 are drive rollers that can each rotate independently, according to the foregoing embodiment. However, the disclosure is not limited to such embodiment. The transport rollers 61 may be composed of follower rollers, and connected to a transport mechanism. In addition, although a single set of the transport rollers 61 is provided in the embodiment, a plurality of sets of transport rollers 61 may be provided. In the case of providing the plurality of sets of transport rollers 61, the abutment member 70 and the displacement device 80 may be configured to move in the transport direction. The disclosure encompasses such a structure that at least one of the abutment member 70 and the displacement device 80 is movable in the transport direction.
(3) As described with reference to FIG. 1 to FIG. 14, the supply roller pair 23 is located upstream of the transport apparatus 2, according to the embodiment. However, the disclosure is not limited to such embodiment. The supply roller pair 23 may be excluded. Alternatively, the sheet P may be temporarily detained by the supply roller pair 23.
(4) As described with reference to FIG. 1 to FIG. 14, two sets of recessed portions, namely the pair of recessed portions 72a and the pair of recessed portions 72b are provided, to prevent the distortion of the corner portion of the sheets of three different sizes, according to the embodiment. However, the disclosure is not limited to such embodiment. One pair of the recessed portions 72a, or three or more pairs of the recessed portions may be provided. The number of pairs of the recessed portions may be determined as desired, depending on the number of types of the sheet P to be transported by the transport apparatus 2. Likewise, although the first detector 207 and the second detector 208 are provided according to the embodiment, the disclosure is not limited thereto. It suffices that at least the quality of the posture of the sheet P can be decided, and from such viewpoint, a single detector, or three or more detectors may be provided.

### INDUSTRIAL APPLICABILITY

The disclosure is applicable to the technical field of the transport apparatus and the image forming apparatus.

What is claimed is:

1. A transport apparatus comprising:
a transport device that transports a sheet in a first direction, corresponding to a sheet transport direction;
an abutment member located on one side of the transport device, in a second direction intersecting the first direction, to be abutted against an edge of the sheet on the one side in the second direction; and
a displacement device that displaces the sheet toward the one side in the second direction, in contact with the sheet.

2. The transport apparatus according to claim 1,
wherein the displacement device contacts the sheet at a first position in the first direction, and
the first position corresponds to a center of gravity of the sheet, or a position on an opposite side of a position where the sheet and the abutment member contact first, with respect to the center of gravity of the sheet.

3. The transport apparatus according to claim 1,
wherein the abutment member includes a recessed portion, recessed toward the one side from the other side in the second direction, and
the abutment member contacts first a position on the sheet other than an end portion of the edge in the first direction, or on an opposite side in the first direction, by stopping transport of the sheet, at a position where the end portion of the edge in the first direction, or on the opposite side in the first direction, is located at the recessed portion.

4. The transport apparatus according to claim 1, further comprising a control device that controls the transport device and the displacement device,
wherein the control device causes the displacement device to start to move the sheet, after causing the transport device to stop transporting the sheet, by locating the sheet at a predetermined position in the sheet transport direction.

5. The transport apparatus according to claim 4,
wherein the transport device includes a transport roller that moves the sheet in contact therewith,
the displacement device includes a displacement roller that moves the sheet in contact therewith, and
the control device is configured to:
move the transport roller away from the sheet, when the displacement device moves the sheet; and
move the displacement roller away from the sheet, when the transport device transports the sheet.

6. The transport apparatus according to claim 4, further comprising a detector that detects a posture of the sheet,
wherein the control device controls the transport device, upon deciding that posture correction of the sheet is insufficient, on a basis of the posture of the sheet detected by the detector, so as to change a stop position of the sheet, from a position where the sheet was stopped in a preceding transport operation.

7. An image forming apparatus comprising:
the transport apparatus according to claim 1; and
an image forming device that forms an image on the sheet.
